(19) United States
(12) Patent Application Publication
(10) Pub. No.: US 2003/0161690 A1
(43) Pub. Date: Aug. 28, 2003

(54) Offshore loading or production system for dynamically positioned ships

(76) Inventors: Kare G. Breivik, Tau (NO); Arild K. Samuelsen, Tananger (NO)

Correspondence Address: FITZPATRICK CELLA HARPER & SCINTO, 30 ROCKEFELLER PLAZA, NEW YORK, NY, 10112, US

(21) Appl. No.: 10/333,474

(22) PCT Filed: Jul. 19, 2001
(86) PCT No.: PCT/NO01/00311

(30) Foreign Application Priority Data
Jul. 20, 2000 (NO) 20003735

(51) Int. Cl. F16L 1/12; E02D 5/62; B63B 21/00

(52) U.S. Cl. 405/224.2; 405/169; 405/172; 114/230.1

(57) ABSTRACT

An offshore loading or production system for dynamically positioned ships, comprising a riser means (4) extending between a supply means and a coupling head (5) for connection to a connecting means (6) on the ship (1). The riser means (4) comprises a lower riser portion (7) extending along the seabed (8) and being arranged to take up a wavy shape above the seabed by means of at least one bottom-anchored first buoyancy element (9), and an upper riser portion (10) of which the lower end is connected to the lower riser portion (7) via a second buoyancy element (11), and of which the upper end is connected to the coupling head (5) via a swivel unit (12). The second buoyancy element (11) is connected to a supporting anchoring (17) extending along the seabed (8) in a direction away from the lower riser portion (7).

The invention relates to an offshore loading or production system for dynamically positioned ships, comprising a riser means extending between a supply means and a coupling head for connection to a connecting means on the ship.

It is an object of the invention to provide a loading or production system of the above-mentioned type which is cost-efficient and which is also suitable for use at smaller water depths than corresponding systems according to the prior art.

Another object of the invention is to provide such a system wherein the coupling head at the upper end of the riser means does not require any repositioning before connection to the relevant ship.

For achieving the above-mentioned objects there is provided a loading system of the introductorily stated type which, according to the invention, is characterised in that the riser means comprises a lower riser portion extending along the seabed and being arranged to take up a wavy shape above the seabed by means of at least one bottom-anchored first buoyancy element, and an upper riser portion of which a lower end is connected to an appurtenant end of the lower riser portion via a second buoyancy element, and of which the upper end is connected to the coupling head via a swivel unit, the upper riser portion being provided with one or more floating bodies, and that he second buoyancy element is connected to a supporting anchoring extending along the seabed in a direction away from the lower riser portion.

The invention will be further described below by means of exemplary embodiments with reference to the drawings, wherein

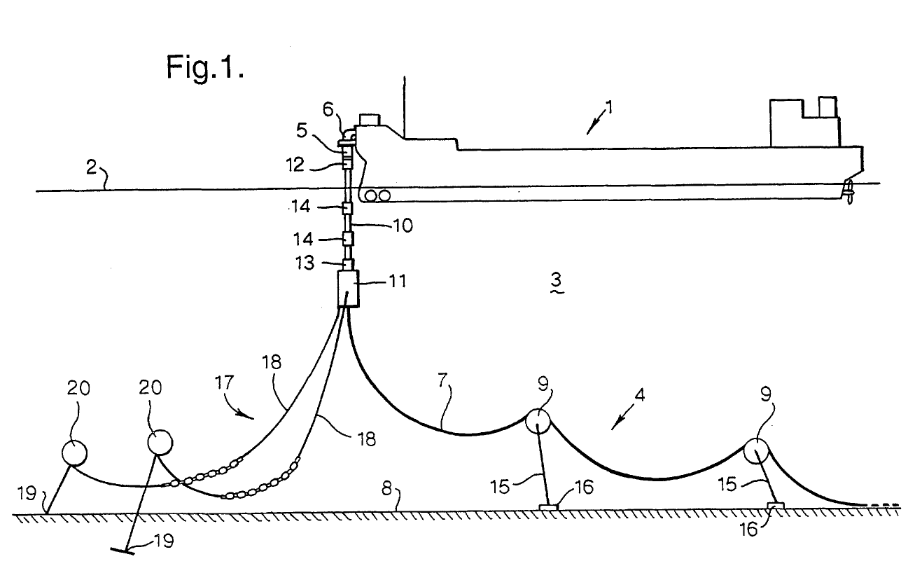

FIG. 1 shows a schematic side view of a loading system according to the invention, with a tanker connected to the system;

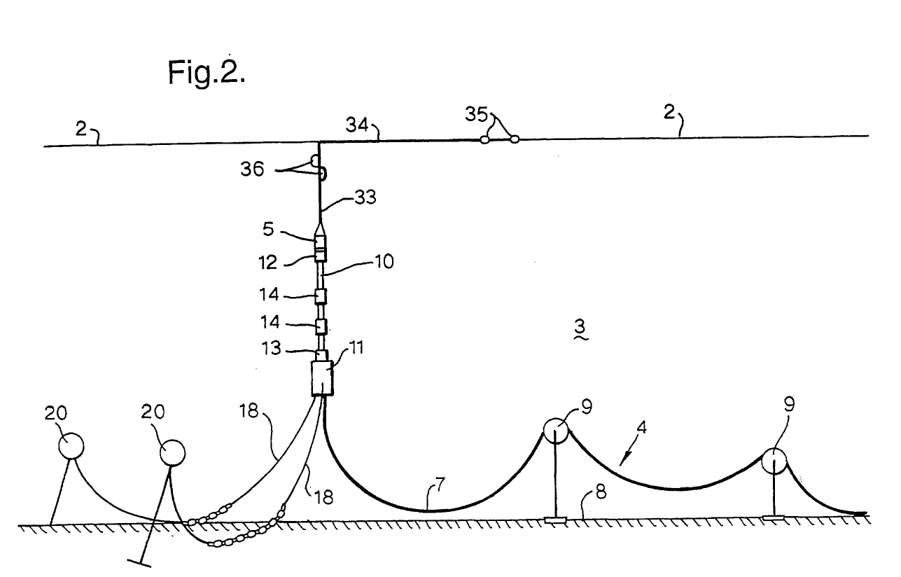

FIG. 2 shows a side view of the system of FIG. 1, in disconnected condition;

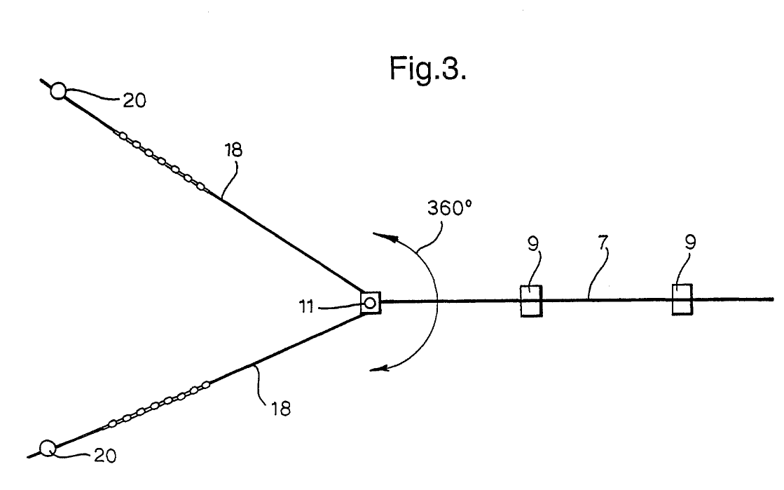

FIG. 3 shows a schematic plan view of the lower part of the system of FIG. 1;

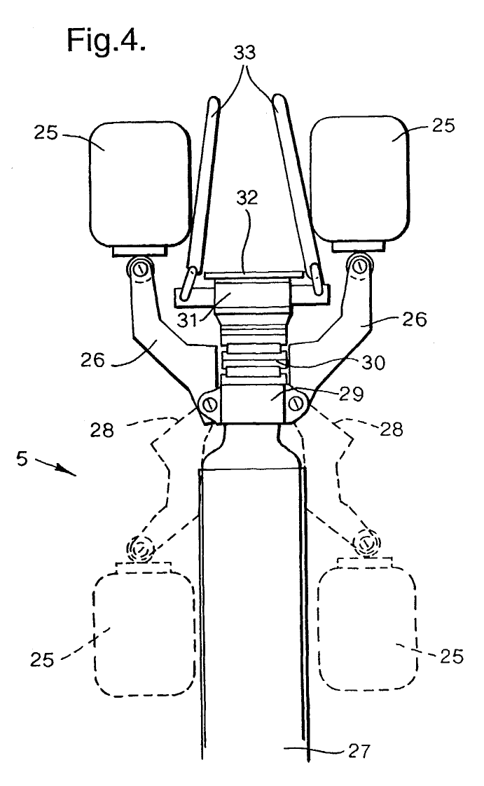

FIG. 4 shows a side view of an embodiment of a coupling head;

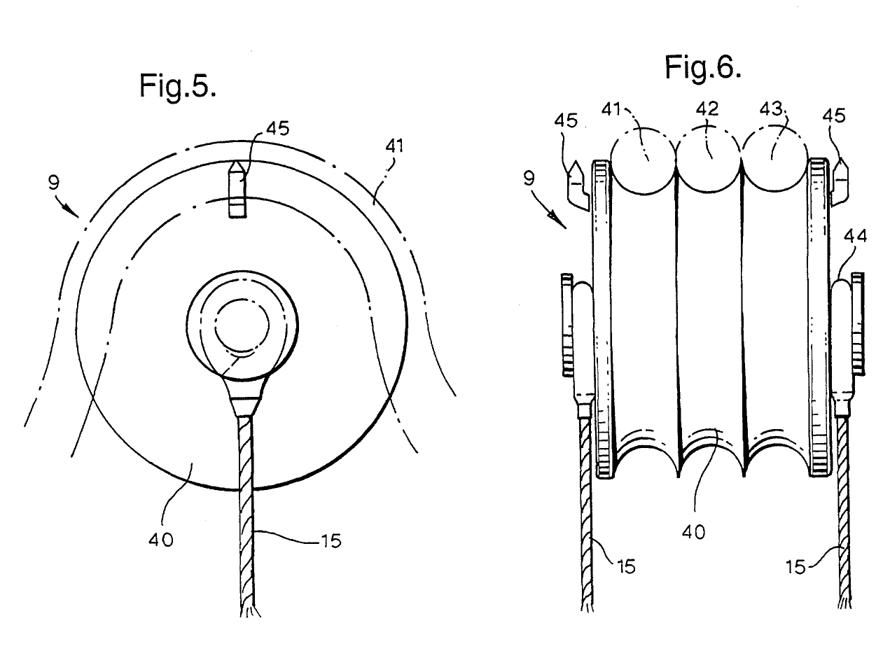

FIG. 5 shows a side view of an embodiment of a bottom-anchored buoyancy element which simultaneously constitutes a supporting element for the lower riser portion;

FIG. 6 shows side view of the buoyancy element of FIG. 5, as viewed in a direction parallel with the plane of FIG. 5;

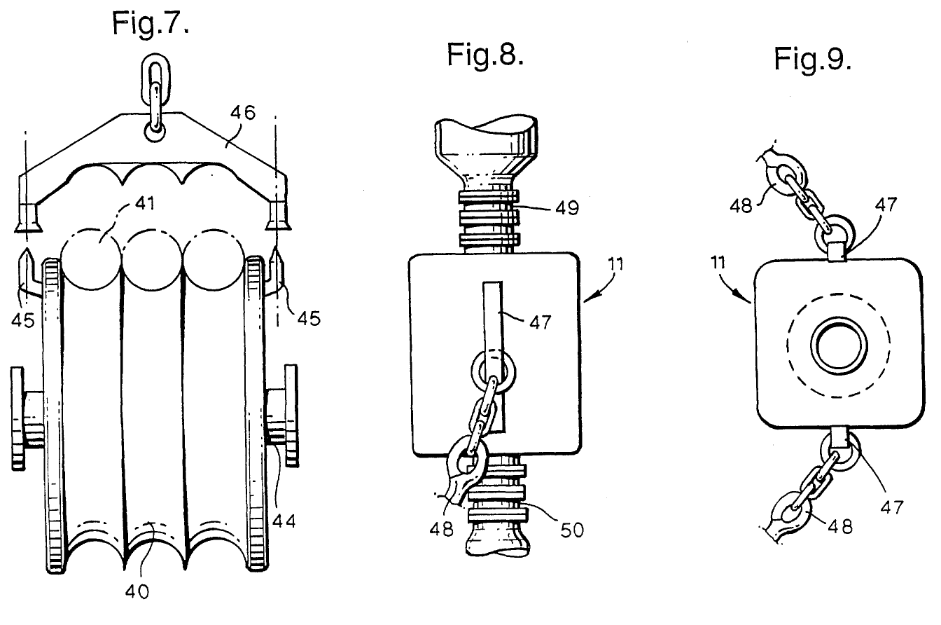

FIG. 7 shows a side view corresponding to that of FIG. 6, wherein the element is provided with a riser stopper; and

FIGS. 8 and 9 show a side view and a plan view, respectively, of an embodiment of the second buoyancy element of the system.

In FIG. 1 there is shown a dynamically positioned tanker (DP-tanker) 1 floating on the surface 2 of a body of water 3, and which is connected to a loading system comprising a riser means 4 extending between a non-illustrated supply means, for example an oil storage on e.g. a near-by production ship, and a coupling head 5 for connection to a load intake in the form of a bow manifold 6 on the tanker.

In accordance with the invention, the riser means 4 comprises a lower riser portion 7 extending along the seabed 8 and being arranged to take up a wavy shape or “hump” shape above the seabed by means of at least one bottom-anchored first buoyancy element 9, and an upper riser portion 10 of which the lower end is connected to the upper end of the lower riser portion 7 via a second buoyancy element 11, and of which the upper end is connected to the coupling head 5 via a swivel unit 12. When required, an additional swivel unit 13 may also be arranged between the buoyancy element 11 and the riser portion 10. A number of floating bodies 14 are arranged along the length of the upper riser portion 10, to secure that this will take up an approximately vertical is configuration in the water. The buoyancy elements 9 and 11 may consist of suitable buoyancy tanks.

The lower riser portion may be designed with a single or double “hump” by the use of respectively one or two buoyancy elements 9, to secure the necessary flexibility in the loading system when the tanker 1 moves under varying environmental loads. In the shown embodiment, the riser portion 7 is connected to a pair of such buoyancy elements 9, each of the elements being anchored to the seabed by means of at least one anchor line 15 which is rotatable about its anchoring point 16 at the seabed under varying dynamics and loads. Thereby an optimum movement characteristic is secured, and that relatively small forces are transferred from the ship to the riser means under the varying and often marginal conditions under which the tankers operate in connection with offshore loading.

The double “hump” configuration is most relevant to use when the water depth is less than about 120 m. This special riser configuration gives an increased flexibility for the tanker. This means that the present system will be able to maintain a higher loading regularity at small water depths than what other known DP-based loading concepts will be able to maintain.

The second buoyancy element 11, which is connected between the lower and the upper riser portion 7 and 10, respectively, further is connected to a light supporting anchoring 17 extending along the seabed 8 in a direction away from the lower riser portion 7. In the shown embodiment, the supporting anchoring comprises two anchor lines 18 diverging away from the lower riser portion 7 from their connection to the second buoyancy element 11, as best shown in the plan view of FIG. 3. The circle sector-shaped double arrow shown in FIG. 3 illustrates that the tanker 1 may turn 360° about the swivel connection between the coupling head 5 and the upper riser portion 10.

Each of the anchor lines 18, in its region close to its anchoring point 19 on the seabed 8, is provided with a buoyancy body 20, to keep the portion in question of the anchor lines in raised position above the seabed. When the tanker 1 is connected to the loading system, the supporting anchoring 17 is lifted up from the seabed and will contribute to securing that the upper riser portion 10 retains its vertical configuration under varying weather conditions and ship movements. When the tanker is disconnected, the supporting anchoring will pull the risers towards a desired storage position. In this position the lower bight portions of the lower riser portion 7 suitably may rest on the seabed.

As regards the coupling head 5 and the topical equipment for connection of the tanker, this in all essentials will correspond to corresponding equipment which is used today for offshore loading operations.

To ensure that the coupling head 5, which normally weighs more than 1 ton, shall not take up an undesired downwards bent position when this part of the system is submerged in the sea, the coupling head may be provided with a special buoyancy arrangement, as shown in the alternative embodiment according to FIG. 4. In this embodiment the coupling head 5 is provided with a pair of buoyancy buoys 25 connected to the outer ends of respective arms 26 which are rotatably connected to a coupling head body 27 at diametrically opposite side thereof. As shown, the arms 26 are provided with supporting surfaces 28 to provide for lateral support of the coupling head body 27 when the coupling head is submerged in the sea and the arms are kept in an upwards directed position by means of the buoyancy buoys 25.

When the upper riser portion 10 with the coupling head 5 is lifted up from the sea, the rotatable arms 26 and the buoys 25 will take up the downwards directed position which is shown stippled in FIG. 4, and thereby take up a position wherein they will not disturb the connection of the coupling head to the bow manifold 6 of the ship.

As appears from FIG. 4, the arms 26 are rotatably connected to fastening lugs on a so-called spool piece 29, and a swivel 30 is arranged between the spool piece and the upper end portion 31 of the coupling head which in turn terminates in a flange 32 for connection to the bow manifold of the ship. The end portion further is connected to a bridle 33 which is connected to a floating line 34, as shown in FIG. 2 which shows the system in the disconnected condition.

As shown in FIG. 2, the floating line 34 is coupled to a pair of floating and marking buoys 35 floating on the water surface 2 in the disconnected condition of the system, for marking the position of the system. Above the bridle, there are further arranged a pair of buoyancy buoy 36 which are coupled to the floating line 34 and contribute to maintaining the vertical configuration of the upper riser portion 10 when the system is disconnected. A swivel (not shown) possibly may be arranged on the floating line above the buoyancy buoys 36.

An embodiment of the first buoyancy element 9 is shown in FIGS. 5-7. The buoyancy element here is formed as a supporting roller 40 having peripheral grooves for the support of up to three risers 41, 42, 43, the system then being presupposed to be adapted for use of several risers in parallel. For example, this may be of interest in connection with floating production systems wherein there is used a DP-based FPSO vessel, i.e. a vessel for floating production, storage and off-loading. The shown supporting roller 40 is rotatably mounted by means of a shaft 44 which at its ends is coupled in a suitable manner to a respective anchor line 15. As shown, the supporting roller 40 at its ends is provided with stand-up pins 45 for guiding and retaining a riser stopper 46 having as its task to keep the risers 41-43 in place on the roller.

FIGS. 8 and 9 show an embodiment of the second buoyancy element 11 of the loading system. The buoyancy element here consists of a buoyancy tank which is provided on opposite sides with fastening lugs 47 having coupling links 48 for connection of the anchor lines 18 of the supporting anchoring. In this embodiment, a swivel 49 and 50, respectively, is arranged both above and below the buoyancy element, on the respective riser portion.

The above described FPSO solution with several parallel risers is very advantageous, as it gives a system having a great movement flexibility at shallow water, as compared to the previously known systems. Effected calculations show that such a ship will be able to move typically ±50 m along the axis in which the risers are oriented at the seabed, and correspondingly about ±25 m transversely to this axis. The ship can turn freely in both directions about the connecting point when this point is located within the allowable movement area defined by the above-mentioned longitudinal and transverse movement of the ship.

An FPSO vessel typically will be provided with a central moonpool where the risers are pulled in. On the vessel the risers are terminated in a motorised high-pressure swivel seeing that the vessel can turn freely around in both directions and be oriented against the prevailing weather direction.

When the system according to the invention is used in connection with a production system, the riser arrangement will be different from the loading variant shown in FIGS. 1 and 2. The upper riser portion with floating bodies and swivels then will be replaced by a coupling head having one or more buoyancy buoys. The riser means will comprise up to three risers having a diameter of e.g. 8-10 inches, and for example two umbilicals for electric and hydraulic signals. Risers and cables are arranged such that they are installed sequentially by the production vessel. Ready installed the risers and cables will lie in parallel over the buoyancy elements, i.e. in respective grooves in the above described rollers (FIGS. 5-7).

The relevant risers and cables are terminated in the above-mentioned coupling head which is pulled into the vessel, preferably in a centrally placed moonpool (as mentioned above), to reduce the dynamical stresses on the risers. An electrically driven swivel at deck level sees to it that the turning of the ship in relation to the weather is compensated as required. The swivel is designed such that risers and coupling head can be disconnected and dropped in the course of about 30 seconds or less. When the coupling head with buoyancy buoy (or buoys) is dropped, it will take up a stabilised, submerged position in the water, and be ready for a new pull-in into the production vessel.

The system according to the invention exhibits a number of advantages which may be summarised as follows:

A cost-efficient system

Can be used at smaller water depths than corresponding known systems

The upper riser portion takes up a vertical position in the sea when a ship is not connected, and does not require any repositioning for connection of a ship

A tanker can couple itself to or from the system without any assistance of a tender

All parts of the system which are subjected to wear, may be raised to the surface for maintainance and replacement

The system may be adapted for use with several parallel risers, and may be used for DP-based FPSO systems.

1. An offshore loading or production system for dynamically positioned ships, comprising a riser means (4) extending between a supply means and a coupling head (5) for connection to a connecting means (6) on the ship (1), characterised in that the riser means (4) comprises a lower riser portion (7) extending along the seabed (8) and being arranged to take up a wavy shape above the seabed by means of at least one bottom-anchored first buoyancy element (9), and an upper riser portion (10) of which the lower end is connected to an appurtenant end of the lower riser portion (7) via a second buoyancy element (11), and of which the upper end is connected to the coupling head (5) via a swivel unit (12), the upper riser portion (10) being provided with one or more floating bodies (14), and that the second buoyancy element (11) is connected to a supporting anchoring (17) extending along the seabed (8) in a direction away from the lower riser portion (7).

2. A loading system according to claim 1, characterised in that the lower riser portion (7) is connected to a pair of first buoyancy elements (9) of which each is anchored by means of at least one anchor line (15) which is rotatable about its anchoring point (16) on the seabed (8).

3. A loading system according to claim 1 or 2, characterised in that the supporting anchoring (17) comprises a pair of anchor lines (18) diverging in a direction away from the lower riser portion (7) from their connection with the second buoyancy element (11).

4. A loading system according to claim 3, characterised in that each of the anchor lines (18) in its region close to its connection with the seabed (8) is provided with a buoyancy body (20) to keep the portion in question of the anchor lines (18) in a raised position above the seabed (8).

5. A loading system according to any one of the preceding claims, characterised in that the first buoyancy element (9) is formed as a supporting roller (40) for the support of at least one riser (41), the roller (40) being rotatably mounted by means of a shaft (44) which at its ends is coupled to a respective anchor line (15).

6. A loading system according to claim 5, characterised in that the supporting roller (40) is provided with a riser stopper (46) to keep the at least one riser (41) in place on the roller.

7. A loading system according to any one of the preceding claims, characterised in that the coupling head (5) is provided with a pair of buoyancy buoys (25) connected to the outer ends of respective arms (26) which are rotatably connected to a coupling head body (27) at diametrically opposite sides thereof, the arms (26) being arranged for lateral support of the coupling head body.

8. A loading system according to any one of the preceding claims, characterised in that the coupling head (5) is connected to a floating line (34) coupled to floating and marking buoys (35) and arranged to float on the water surface (2) when the system is not in use.

9. A loading system according to claim 8, characterised in that the floating line (34) is connected to the coupling head (5) via a bridle (33).

10. A loading system according to claim 9, characterised in that at least one buoyancy buoy (36) is arranged on the floating line (34) above the bridle (33).
